(19) United States
(12) Patent Application Publication
(10) Pub. No.: US 2004/0265003 A1
(43) Pub. Date: Dec. 30, 2004

(54) Electrophotographic photoreceptor

(76) Inventors: Motoi Ebizuka, Matsumoto (JP); Akira Terasawa, Matsumoto (JP)

Correspondence Address: RABIN & BERDO, P.C., SUITE 500, 1101 14th Street, N.W., Washington, DC, 20005, US

(21) Appl. No.: 10/829,465

(22) Filed: Apr. 22, 2004

(30) Foreign Application Priority Data
May 30, 2003 (JP) JP PA 2003-154474

(51) Int. Cl. G03G 15/00

(52) U.S. Cl. 399/159; 399/167

(57) ABSTRACT

An electrophotographic photoreceptor for incorporation in a process cartridge and removably mounted in the main body of an electrophotographic device. The photoreceptor includes a photosensitive drum having a cylindrical conductive substrate and a photosensitive layer formed on the substrate's outer peripheral surface. The photoreceptor has a gear flange engaged with an open end of the drum, for transmitting rotational driving force from the main body to the drum. A driving force transmitting section, designed to achieve rotational accuracy and rotational strength and realize reduced production costs, includes at least two projected portions inclined in a direction substantially opposite to the rotational direction of the drum, and arranged concentrically about the central axis of the drum. The driving force transmitting section also includes a raised portion, formed on a rotational driving force receiving surface of the gear flange, which reinforces an area between the projected portions.

### BACKGROUND OF THE INVENTION

1. Field of the Invention

The invention relates to an electrophotographic photoreceptor (hereinafter also referred to simply as “photoreceptor”), and more particularly to an electrophotographic photoreceptor with an improved gear flange, which transmits rotational driving force from an electrophotographic device to a photosensitive drum when the electrophotographic photoreceptor incorporated in a process cartridge is used.

2. Prior Art

In general, an electrophotographic photoreceptor is formed such that flanges or gear flanges are connected to both ends of a photosensitive drum having a photosensitive layer formed on the outer peripheral surface of a conductive substrate. This photoreceptor is loaded into a process cartridge, and mounted in an electrophotographic device such as a copier, a printer, or a facsimile machine.

The process cartridge is a cartridge that integrally stores an electrifying member for direct application of voltage (including erasing) and various members required for electrophotographic processes such as development and cleaning, which are disposed around the electrophotographic photoreceptor. The process cartridge is removably mounted in the electrophotographic device, and functions as an essential element for image formation.

In the electrophotographic device with the process cartridge mounted therein, a latent image is formed by exposing the electrophotographic photoreceptor, which has been uniformly electrified by an electrification process, according to image information. Then, the latent image is developed using toner by a development process to form a toner image on the photoreceptor. Further, the toner image is transferred onto a base such as a sheet by a transfer process to form an image.

Conventionally, the above-described process cartridge has been widely used in the electrophotographic device based on the electrophotographic process. The use of the process cartridge substantially eliminates the necessity of performing maintenance on the main body of the device. That is, maintenance of the device can be performed very easily.

In the process cartridge, the electrophotographic photoreceptor carries out an electrophotographic process by rotating in response to a rotational driving force transmitted from the device. To transmit the driving force, a flange is usually joined to an open end of the photosensitive drum.

If the gear flange connected to the photosensitive drum falls off the photoreceptor, or the place at which the gear flange is joined to the photosensitive drum becomes loosened, the photoreceptor stops rotating since no driving force is transmitted, and this causes serious problems such as breakdown of the device and image interference such as jitter. To avoid such problems, it is technically important to ensure the long-term reliability of the place at which the gear flange is joined to the photosensitive drum.

On the other hand, if a driving force transmitting section of the flange and a driving force transmitting section of the main body of the device are engaged with each other with a degree of low accuracy, image interference may occur, since the driving force is not satisfactorily transmitted. Therefore, it is important to maintain a high rotational accuracy of the flange over a long period of time by optimizing the state of engagement between the driving force transmitting sections to reliably transmit the driving force, as well as to ensure the long-term reliability of the place at which the flange is joined to the photosensitive drum.

As for improvements of the driving force transmitting section of the flange, Japanese Laid-Open Patent Publication (Kokai) No.8-328449, for example, discloses a technique for improving the rotational accuracy of the electrophotographic photosensitive drum. According to this technique, a predetermined twisted hole is formed in a gear of the main body of the device, and a twisted projection is formed at one end of the photosensitive drum in the longitudinal direction thereof, so that a rotational driving force is transmitted through engagement between the hole and the projection. Further, Japanese Laid-Open Patent Publication (Kokai) No.2001-324845 discloses a technique for reliably transmitting a driving force and preventing vibrations of the process cartridge. According to this technique, an engagement hole and a projected portion are formed in a gear of the main body of the device, and an engagement projection and an abutment portion circumscribing the projected portion are formed in the process cartridge, so that the main body of the device and the process cartridge are connected and aligned with each other to reliably transmit the driving force and prevent vibrations of the process cartridge.

Further, U.S. Pat. No. 6,173,146 discloses a technique relating to a developing cylinder and a drive gear that are provided with improved driving force transmitting sections. The improved driving force transmitting sections have a design that enables a driving force transmitting section of a flange of the developing cylinder to be quickly injection molded from plastics through a mass fabrication process.

### OBJECTS AND SUMMARY OF THE INVENTION

As stated above, although various considerations have been given to the structure of the driving force transmitting section of the flange, a more practical flange has been desired that can realize increased rotational strength providing the driving force, to raise the long-term reliability of the rotational accuracy, and can also realize reduced production costs.

It is therefore an object of the invention to provide an electrophotographic photoreceptor with an improved driving force transmitting section of a flange, which can realize a high rotational accuracy when used in an electrophotographic device, can maintain the high rotational accuracy over a long period of time, and also can realize reduced production costs.

To attain the above object, there is provided an electrophotographic photoreceptor used in a process cartridge and removably mounted in a main body of an electrophotographic device. The electrophotographic photoreceptor includes a photosensitive drum constructed with a photosensitive layer that includes a photoconductive material on an outer peripheral surface of a cylindrical conductive substrate. A gear flange is engaged with an open end of the photosensitive drum for transmitting rotational driving force from the main body of the electrophotographic device to the photosensitive drum. A driving force transmitting section of the gear flange includes at least two projected portions inclined in a direction substantially opposite to a rotational direction of the photosensitive drum and arranged concentrically about a central axis of the photosensitive drum. A raised portion of the driving force transmitting section is formed on a rotational driving force receiving surface of the gear flange, and serves to reinforce an area between the at least two projected portions.

### BRIEF DESCRIPTION OF THE DRAWINGS

FIG. 1(a) is a fragmentary enlarged perspective view showing an electrophotographic photoreceptor according to an embodiment of the invention, and FIG. 1(b) is a front view of thereof as viewed in a longitudinal direction from an end of the photoreceptor.

FIG. 1(c) is a fragmentary cross-sectional view of the photosensitive drum according to the invention.

FIG. 2(a) is a fragmentary enlarged perspective view showing a driving force transmitting section of the main body of an electrophotographic device, which corresponds to a gear flange shown in FIGS. 1(a) and 1(b), and FIG. 2(b) is a front view of the driving force transmitting section shown FIG. 2(a) as viewed in an engaging direction.

FIG. 3 is a fragmentary enlarged perspective view showing a gear flange according to a comparative example 1.

FIG. 4 is a fragmentary enlarged perspective view showing a driving force transmitting section of the main body of an electrophotographic device according to the comparative example 1 shown in FIG. 3.

FIG. 5(a) is a fragmentary enlarged perspective view showing a gear flange according to a comparative example 2, and FIG. 5(b) is a front view of the gear flange of FIG. 5(a) as viewed from an end of the photoreceptor in the longitudinal direction thereof.

### DETAILED DESCRIPTION OF THE PREFERRED EMBODIMENTS

A preferred embodiment of the invention will be described below in detail with reference to the accompanying drawings.

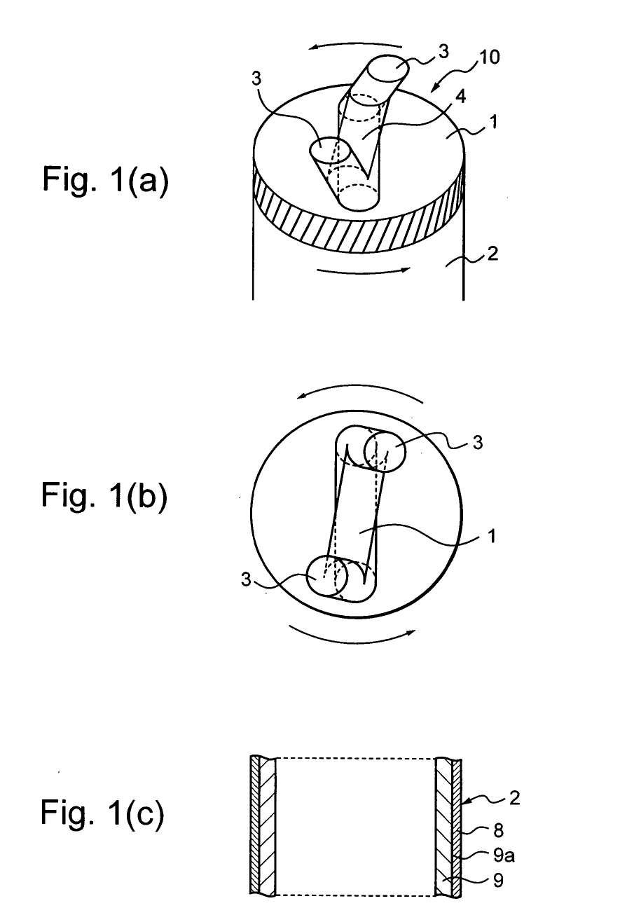

Referring to FIGS. 1(a) and 1(b), a photoreceptor 10 according to the invention is a photoreceptor for a process cartridge, which is incorporated in the process cartridge detachably mounted in the main body of an electrophotographic device. As shown in FIGS. 1(a), the photoreceptor 10 is provided with a photosensitive drum 2 and a gear flange 1 engaged with an open end of the photosensitive drum 2. Rotational driving force is transmitted from the main body of the device to the photosensitive drum 2 via the gear flange 1, so that an electrophotographic process is carried out.

The flange gear 1 of the photoreceptor 10 according to the invention includes a driving force transmitting section comprised of a plurality of projected portions 3 arranged concentrically about the central axis of the photosensitive drum 2, and a raised portion 4 disposed between the projected portions 3. The projected portions 3 and the raised portion 4 are formed on a rotational driving force receiving surface of the gear flange 1. As shown in FIG. 1(a), the projected portions 3 are properly inclined in a direction substantially opposite to the rotational direction of the photosensitive drum 2 indicated by arrows in FIG. 1(a), so that the rotational driving force can be transmitted mainly via the projected portions 3.

It is necessary to provide at least two projected portions 3 so as to reliably transmit rotational driving force to the photosensitive drum 2 without causing deflection of the central axis thereof, but it is preferred that three or more projected portions 3 are provided to realize a higher rotational accuracy. Although it is preferred that the plurality of projected portions 3 are arranged concentrically as described above, at regular intervals in the circumferential direction, the invention is not limited to this, so if a large number of projected portions 3 are provided, they may be arranged at irregular intervals.

The projected portion 3 need not have a substantially circular columnar shape insofar as it is properly inclined so as to receive rotational driving force as described above. For example, the projected portion 3 may have a substantially rectangular columnar shape. Also, the dimensions of each projected portion 3 are not limited, but rather can be determined according to the dimensions of the gear flange 1 itself. In the preferred embodiment, however, the shape and dimensions of the projected portion 3 are determined so that the projected portion 3 can be engaged with a driving force transmitting section of the main body of the device.

The raised portion 4 is provided for reinforcing the projected portions 3, and need not be shaped as illustrated, provided that it can add to the strength of the projected portions 3. Also, the dimensions of the raised portion 4 may be determined according to e.g. the shape of the projected portions 3. If the raised portion 4 is not provided, the projected portions 3 may break when actually used since a large torque is applied to the projected portions 3 in driving, and thus, the reliability in long-term usage may not be ensured.

The driving force transmitting section of the flange 10 according to the invention can be formed easily by e.g. injection molding. Further, the driving force transmitting section of the flange 10 can be made of a small number of materials due to its structure, and hence can realize reduced production costs.

According to the present embodiment, desired effects can be obtained insofar as the gear flange 1 satisfies the above-described requirements, and the material, structure, and so forth of the gear flange 1 are not limited. For example, the gear flange 1 may be constructed as described below.

Examples of the material of the gear flange 1 include various general-purpose resin materials such as polycarbonate, polyacetal, and polybutylene telephthalate, and the gear flange 1 may be made of a mixture of one or more such materials.

As shown in FIG. 1(c), the photosensitive drum 2 is constructed such that a photosensitive layer 8 containing a photoconductive material is formed on the outer peripheral surface 9a of a cylindrical conductive substrate (hereinafter also referred to simply as “substrate”) 9. According to the invention, other materials are acceptable for the substrate and the photosensitive layer insofar as they exhibit characteristics required for the photoreceptor. Examples of the material of the substrate include aluminum, aluminum alloy, and aluminum film deposited on the surface of a cylindrical plastic material. On the other hand, examples of the photoconductive material of the photosensitive layer include publicly known charge generation materials such as various phthalocyanine compounds and publicly known charge transport materials such as various hydrazone compounds. Such a material as well as other adhesive materials or the like are diffused or dissolved in a binder, and applied in a layer structure to form the photosensitive layer by a publicly known method such as a dip-coating method. The photosensitive layer may be either double-layered, to include a charge generation layer and a charge transport layer, or single-layered, and further, an undercoat layer may be interposed between the substrate and the photosensitive layer.

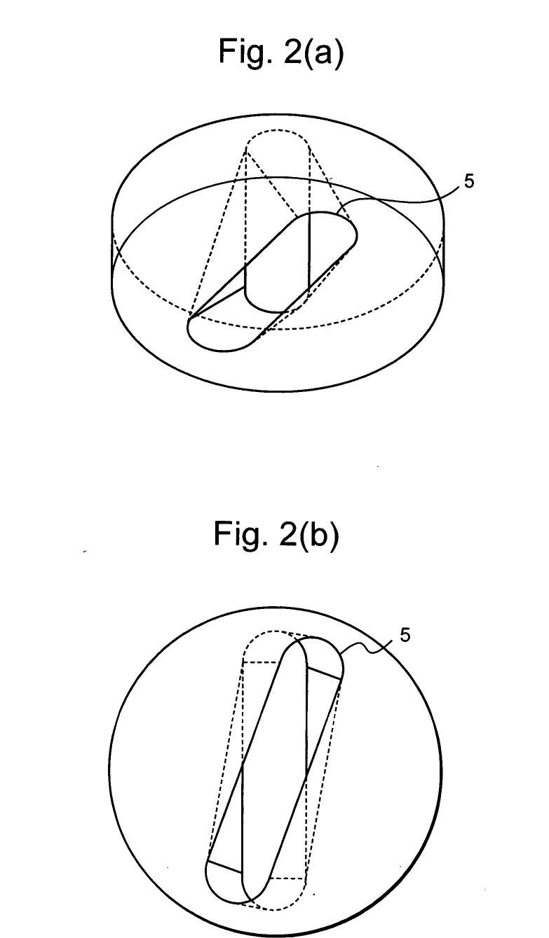

FIGS. 2(a) and 2(b) schematically show an example of the driving force transmitting section of the main body of the device, which can be engaged with the driving force transmitting section of the gear flange 1 appearing in FIGS. 1(a) and 1(b). As shown in FIGS. 2(a) and 2(b), a twisted hole 5, which can be engaged with the projected portions 3 and the raised portion 4 of the gear flange 1, is formed in the driving force transmitting section of the main body of the device. If the projected portions 3 and the raised portion 4 are engaged with the hole 5, the driving force can be transmitted.

### EXAMPLES

The invention will now be described in further detail by way of examples. However, the invention is not limited thereto.

A photosensitive drum was fabricated by forming an undercoat layer, a charge generation layer, and a charge transport layer in this order by a dip-coating method, on the outer peripheral surface of a drum-shaped substrate made of an aluminum alloy of JIS 6000 s, with an outer diameter of 30 mm and a length of 260.5 mm. The charge generation layer was made of a coating liquid in which titanylphthalocyanine, as a well known charge generation material, are dispersed in polyvinyl butyral resin. Further, the charge transport layer was made of a coating liquid in which hydrazone, as well known charge transport material, are dissolved in polycarbonate resin.

### Example 1

First, ten gear flanges shaped as shown in FIGS. 1(a) and 1(b) were fabricated. Then, ten photosensitive drums as described above were prepared, and the inner surfaces of open ends of the ten photosensitive drums were coated with the same amount of cyanoacrylate adhesive (in particular, Loctite (registered trademark) 403 produced by Loctite Japan Corporation). Then, the fabricated gear flanges were fitted into the photosensitive drums, and as a result, ten photoreceptors comprised of the photosensitive drums and the gear flanges were obtained.

After the adhesion, the photoreceptor was left at normal temperature and humidity for 24 hours, and incorporated into a process cartridge, which was then loaded into a printer (print speed: 45 sheets per minute). Then, at the initial stage and after printing of 10,000 sheets, 25% halftones were printed to check whether or not image interference such as jitter occurred. It should be noted that the photoreceptor driving torque required for actual usage in the printer was 3.8 N·m. Further, the driving force transmitting section of the printer that was used is structured as shown in FIGS. 2(a) and 2(b). Table 1 shows the image evaluation results.

TABLE 1

| | Photoreceptor No. | | | | | | | | | |
|---|---|---|---|---|---|---|---|---|---|---|
| | 1 | 2 | 3 | 4 | 5 | 6 | 7 | 8 | 9 | 10 |
| Initial Jitter | No | No | No | No | No | No | No | No | No | No |
| Jitter after printing | No | No | No | No | No | No | No | No | No | No |
| 10,000 sheets | | | | | | | | | | |

The results presented in the above Table 1 show that the photoreceptor using the gear flange shaped as shown in FIGS. 1(a) and 1(b) does not cause jitter, and can stably obtain a high-quality image. Further, during printing, no other kinds of image interference were found.

### Comparative Example 1

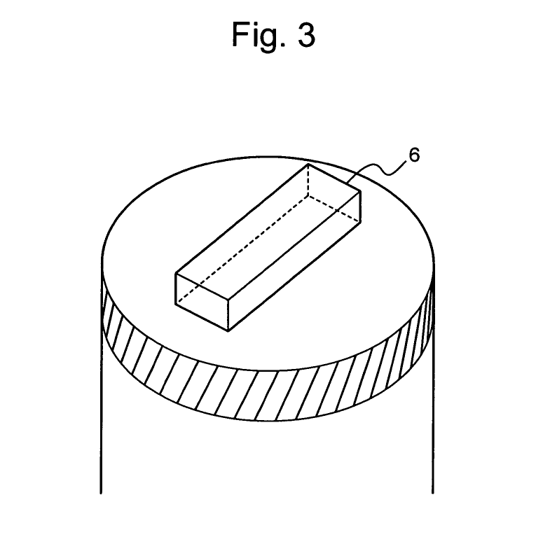

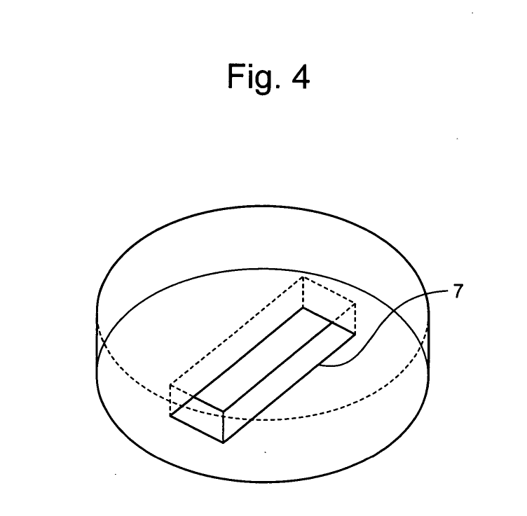

Ten photoreceptors were fabricated in the same manner as was the Example 1 except that gear flanges were shaped as shown in FIG. 3, and the same evaluation as was performed on the Example 1 was carried out. As shown in FIG. 3, this gear flange had only one projection 6 having a rectangular column shape. It should be noted that the driving force transmitting section of a printer which was used was structured as shown in FIG. 4, and a hole 7 that can be engaged with the rectangular column-shaped projection 6 was formed in the driving force transmitting section. Table 2 shows the image evaluation results.

TABLE 2

| | Photoreceptor No. | | | | | | | | | |
|---|---|---|---|---|---|---|---|---|---|---|
| | 11 | 12 | 13 | 14 | 15 | 16 | 17 | 18 | 19 | 20 |
| Initial Jitter | No | No | No | No | No | No | No | No | No | No |
| Jitter after printing | No | No | Slight jitter | No | No | No | Slight jitter | No | No | No |
| 10,000 sheets | | | after 8,000 | | | | after 5,000 | | | |
| | | | sheets | | | | sheets | | | |

The results presented in the above Table 2 show that the photoreceptor using the gear flange shaped as shown in FIG. 3 may cause jitter during printing. Further, the gear flange in FIG. 3 does not have any projected portion as in the gear flange appearing in FIG. 1 or the like, and hence accuracy is unlikely to be obtained in molding.

### Comparative Example 2

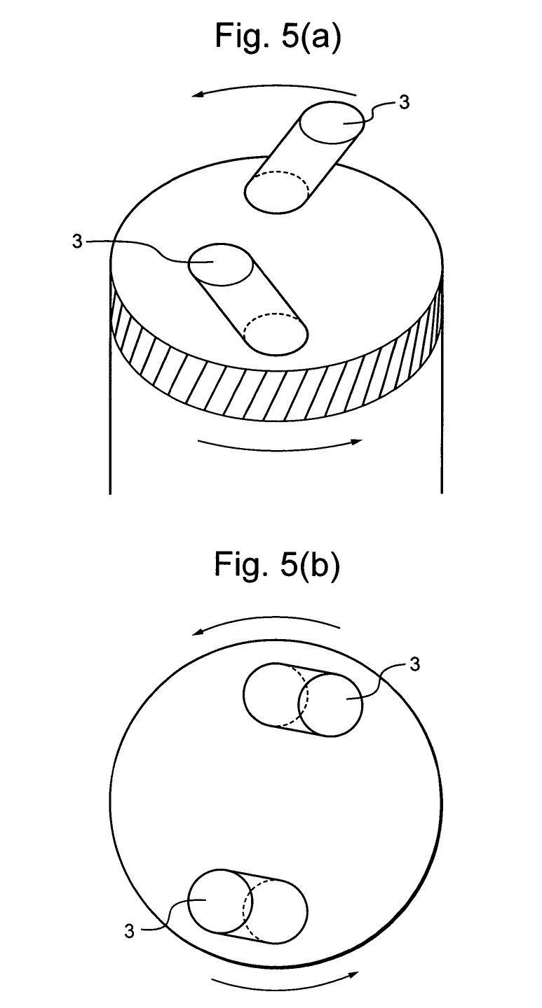

Ten photoreceptors were fabricated in the same manner as in the Example 1 except that gear flanges were shaped as shown in FIG. 5, and the same evaluation was performed on the Example 1 was carried out. As shown in FIG. 5, the gear flange had the projected portions 3, and did not have the raised part 4. It should be noted that the driving force transmitting section of a printer which was used was structured as shown in FIGS. 2(a) and 2(b). Table 3 shows the image evaluation results.

TABLE 3

| | Photoreceptor No. | | | | | | | | | |
|---|---|---|---|---|---|---|---|---|---|---|
| | 21 | 22 | 23 | 24 | 25 | 26 | 27 | 28 | 29 | 30 |
| Initial Jitter | No | No | No | No | No | No | No | No | No | No |
| Jitter after | No | Projection | Projection | No | No | No | Projection | No | Projection | No |
| printing | | broken after | broken after | | | | broken after | | broken after | |
| 10,000 sheets | | 3,000 sheets | 5,000 sheets | | | | 4,000 sheets | | 7,000 sheets | |

The results presented in the above Table 3 show that in the photoreceptor using the gear flange shaped as shown in FIG. 5, the projected portions 3 may break during printing. According to the results presented in the Table 3, the gear flange shown in FIG. 5 has a low strength, and therefore cannot withstand the rotational forces when used in the printer.

As described above, according to the invention, the improved driving force transmitting section of the gear flange realizes an electrophotographic photoreceptor that can exhibit high rotational accuracy and rotational strength during printing, and can also reduce manufacturing costs.

This application claims foreign priority benefits of Japanese patent application no. 2003-154474, the entire disclosure of which is incorporated herein be reference.

What is claimed is:

1. An electrophotographic photoreceptor for incorporation in a process cartridge and removably mounted in a main body of an electrophotographic device, comprising:
a photosensitive drum including
a cylindrical conductive substrate, and
a photosensitive layer formed on an outer peripheral surface of the substrate, the photosensitive layer including a photoconductive material; and
a gear flange engaged with an open end of the photosensitive drum, for transmitting a rotational driving force from the main body of the electrophotographic device to the photosensitive drum, the gear flange having a rotational driving force receiving surface, the gear flange including a driving force transmitting section with
at least two projected portions projecting from the rotational driving force receiving surface, the projected portions being inclined in a direction substantially opposite to a rotational direction of the photosensitive drum and arranged concentrically about a central axis of said photosensitive drum, and
a raised portion that reinforces an area between the at least two projected portions, the raised portion formed on the rotational driving force receiving surface.

2. An electrophotographic photoreceptor according to claim 1, wherein the at least two projected portions includes at least three projected portions.
